(19) United States
(12) Patent Application Publication
(10) Pub. No.: US 2018/0268453 A1
(43) Pub. Date: Sep. 20, 2018

(54) COMPOSITE IMAGE GENERATION

(71) Applicant: eBay Inc., San Jose, CA (US)

(72) Inventors: Dane Glasgow, Los Altos, CA (US); Matthew Bret MacLaurin, Santa Cruz, CA (US); David Ramadge, San Jose, CA (US); Corinne Elizabeth Sherman, San Jose, CA (US); Anthony Shah, Santa Clara, CA (US); Theodore James Dziuba, San Mateo, CA (US); Josephine Pang, San Francisco, CA (US)

(21) Appl. No.: 15/985,234

(22) Filed: May 21, 2018

Related U.S. Application Data
(63) Continuation of application No. 14/725,166, filed on May 29, 2015.

(51) Int. Cl. G06Q 30/06; G06T 7/00; G06Q 30/02; G06F 17/30

(52) U.S. Cl. CPC G06Q 30/0619; G06T 2207/30168; G06T 7/0002; G06F 17/30265; G06Q 30/0278

(57) ABSTRACT

Aspects of the present disclosure include a system comprising a computer-readable storage medium storing at least one program and computer-implemented methods for generating a composite image. Consistent with some embodiments, a method includes receiving a first image captured by a camera on a user device and a request for a composite image based on the first image. A database of images is queried based on the first image to identify a second image. The second image is provided to the user device for presentation via an application running on the user device. A selection of one or more image elements from the second image is received via the application running on the user device. The composite image is generated by replacing one or more elements of the first image with the selected one or more elements from the second image, and the composite image is provided to the user device.

### RELATED APPLICATIONS

This patent application is a continuation of U.S. patent application Ser. No. 14/725,166, filed May 29, 2015, which is incorporated herein by reference in its entirety.

### BACKGROUND

With the proliferation of cameras and large storage capacities on mobile devices, there is now an abundance of photos from around the world in existence. A large portion of these images are unused or have not yet been discovered by anyone other than a photographer. Though a portion of these images may be of high quality, many photographers do not have the time, talent, or equipment to take quality images, and thus, many images are often lacking in quality. As a result, would-be photographers may refrain from taking certain pictures, or if they do take a picture, the resulting images may not depict scenery with the quality desired by the photographer or the pictures may not be fit for their intended purpose.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a network system having a client-server architecture configured for exchanging data over a network with a network-based image marketplace, according to example embodiments.

FIG. 2 is a block diagram depicting various functional components of an image marketplace application, which is provided as part of the network system, according to example embodiments.

FIG. 3 is an interaction diagram depicting example exchanges between a client device and an application server, according to example embodiments.

FIG. 4 is a flow chart illustrating a method for providing images to a server hosting the image marketplace application, according to an example embodiment.

FIG. 5 is a flow chart illustrating a method for populating an image repository associated with the image marketplace application, according to an example embodiment.

FIG. 6 is a flow chart illustrating a method for performing image quality analysis, according to an example embodiment.

FIG. 7 is a flow chart illustrating a method for providing image data in response to a user request, according to an example embodiment.

FIG. 8 is a flow chart illustrating a method for providing an image file stored in the image repository, according to an example embodiment.

FIG. 9 is a flow chart illustrating a method for providing a composite image, according to an example embodiment.

FIG. 10 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that these examples are not intended to limit the scope of the claims to the illustrated embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details.

Aspects of the present disclosure involve a network-based high-quality image marketplace. Example embodiments include systems and methods for establishing a collection of high-quality images to be transacted at the image marketplace. The methods may include receiving image data uploaded from a user device. The image data includes an image file (e.g., a set of computer-readable information comprising an image) and metadata describing aspects of the image file (e.g., a location where the image was captured). The received image data is evaluated to determine whether the image is of high enough quality (e.g., above a certain quality threshold) to include in the image marketplace. Images that are deemed high-quality (e.g., above the quality threshold) are further processed to remove (e.g., blur or obscure) visible human faces, and to identify any items of interest that may be visible in the images. These high-quality images are then added to the marketplace's image collection, and made available for purchase by users. Users may search for images by location or by items of interest included in the image.

Further example embodiments include systems and methods for facilitating transactions at the network-based image marketplace. A system receives a user request for an image, hosted by the image marketplace that depicts a particular location. The user request includes an identifier of the particular location. In some instances, the user request may be for a basic (e.g., unenhanced) image of the location, while in other instances the user may request an image that has been enhanced using image filters and other image enhancing techniques. In still other instances, a user may wish to improve their own image using elements from a high-quality image provided by the image marketplace. In these instances, the user request may be for a composite image, and the user is provided with an additional interface to specify particular elements from the image that are to be used to improve the user's own image.

Upon receiving the user request, the system retrieves an image file from the collection of images that corresponds to the location requested by the user. The system then composes image data in accordance with the user request. That is, the system may compose an image file that includes an unenhanced, enhanced, or composite image in a traditional image file format (e.g., JPEG or TIFF). The system then determines a price for the image data based, for example, on a relationship between the device requesting the image and the location of the image. After receiving a payment in the amount of the determined price, the system provides the image data to the requesting device.

As an example of the operation of the network-based image marketplace, a tourist visiting the Golden Gate Bridge wishes to have a photograph of the Golden Gate Bridge. If the user is unable to take a clear photograph with their own camera (or camera-enabled phone) at the time of their visit because of weather or because of a dead battery, the user may instead use a mobile application designed for use with the network-based image marketplace to search through and find other high-quality images of the Golden Gate Bridge. The user may purchase an unenhanced or enhanced version of one of the high-quality images, or the user may purchase a composite image using elements of one of the high-quality images to enhance or improve their own image.

With regard to price, the network-based image marketplace may provide the high-quality image to the user at no cost because the user had previously visited the Golden Gate Bridge. In contrast, another user, who has never been to the Golden Gate Bridge, may have to purchase the photograph from the network-based image marketplace at a premium because the user has never been to the Golden Gate Bridge. Further, in instances in which the other user creates a composite image, the purchase price of the composite image for the other user may depend on the amount of the high-quality image used in making the composite image.

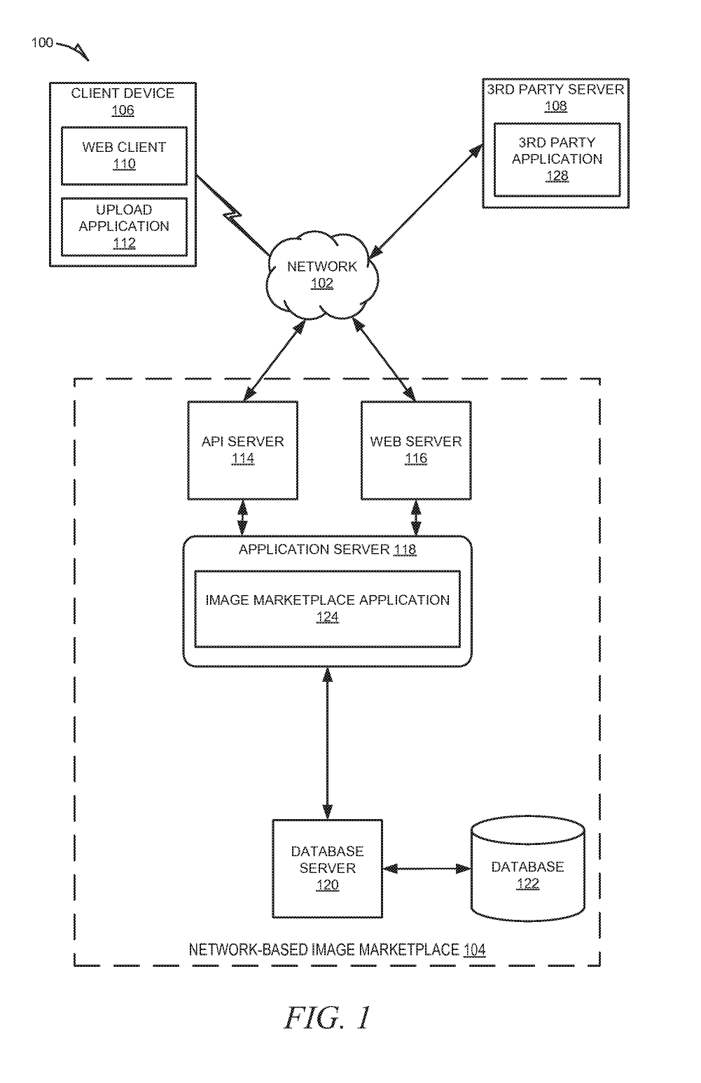

FIG. 1 is a network diagram depicting a network system 100, according to one embodiment, having a client-server architecture configured for exchanging data over a network 102 (e.g., the Internet). While the network system 100 is depicted as having a client-server architecture, the present inventive subject matter is, of course, not limited to such an architecture, and could equally well find application in an event-driven, distributed, or peer-to-peer architecture system, for example. Further, to avoid obscuring the inventive subject matter with unnecessary detail, various functional components that are not germane to conveying an understanding of the inventive subject matter have been omitted from FIG. 1. Moreover, it shall be appreciated that although the various functional components of the network system 100 are discussed in a singular sense, multiple instances of any one of the various functional components may be employed.

The network system 100 includes a network-based image marketplace 104 in communication with a client device 106 and a third party server 108 over the network 102. In some example embodiments, the network-based image marketplace 104 may be a network-based marketplace (e.g., eBay.com). The network-based image marketplace 104 communicates and exchanges data within the network system 100 that may pertain to various functions and aspects associated with the network system 100 and its users. The network-based image marketplace 104 may provide server-side functionality, via the network 102, to network devices such as the client device 106.

The client device 106 is operated by users who use the network system 100 to exchange data over the network 102. These data exchanges include transmitting, receiving (communicating), and processing data to, from, and regarding content and users of the network system 100. The data may include, but are not limited to, images; video or audio content; user preferences; product and service feedback, advice, and reviews; product, service, manufacturer, and vendor recommendations and identifiers; product and service listings associated with buyers and sellers; product and service advertisements; auction bids; transaction data; user profile data; and social data, among other things.

In various embodiments, the data exchanged within the network system 100 may be dependent upon user-selected functions available through one or more client or user interfaces (UIs). The UIs may be associated with a web client 110 (e.g., an Internet browser) operating on the client device 106, which is in communication with the network-based image marketplace 104. The UIs may also be associated with one or more applications executing on the client device 106, such as a mobile application specifically designed for interacting with the network-based image marketplace 104. For example, the client device 106 executes an upload application 112 that facilities the uploading of content (e.g., images) to the network-based image marketplace 104.

Turning specifically to the network-based image marketplace 104, an API server 114 and a web server 116 are coupled to, and provide programmatic and web interfaces respectively to, an application server 118. As illustrated in FIG. 1, the application server 118 is coupled via the API server 114 and the web server 116 to the network 102, for example, via wired or wireless interfaces. The application server 118 is, in turn, shown to be coupled to a database server 120 that facilitates access to a database 122. In some examples, the application server 118 can access the database 122 directly without the need for the database server 120. The database 122 may include multiple databases that may be internal or external to the network-based image marketplace 104.

The application server 118 may, for example, host one or more applications, which may provide a number of content publishing and viewing functions and services to users who access the network-based image marketplace 104. For example, the network-based image marketplace 104 may host an image marketplace application 124 that provides a number of marketplace functions and image services to users, such as image processing, publishing, listing, and price-setting mechanisms whereby the image marketplace application 124 may list (or publish information concerning) images for sale, a buyer can express interest in or indicate a desire to purchase images or image enhancement services, and a price can be set for a transaction pertaining to the images.

The database 122 includes a repository of images (e.g., data files representing images) to be sold using the image marketplace application 124. The database 122 may also be used to store data pertaining to various functions and aspects associated with the network system 100 and its users. For example, the database 122 may store and maintain user profiles for users of the network-based image marketplace 104. Each user profile may comprise user profile data that describes aspects of a particular user. The user profile data may, for example, include demographic data (e.g., gender, age, location information, employment history, education history, contact information, familial relations, or user interests), user preferences, social data, and financial information (e.g., an account number, a credential, a password, a device identifier, a user name, a phone number, credit card information, bank information, a transaction history, or other financial information which may be used to facilitate online transactions by the user).

FIG. 1 also illustrates a third party application 128 executing on the third party server 108 that may offer information or services to the application server 118 or to users of the client device 106. The third party application 128 may have programmatic access to the network-based image marketplace 104 via a programmatic interface provided by the API server 114. The third party application 128 may be associated with any organization that conducts transactions with or provides services to the application server 118 or to users of the client device 106.

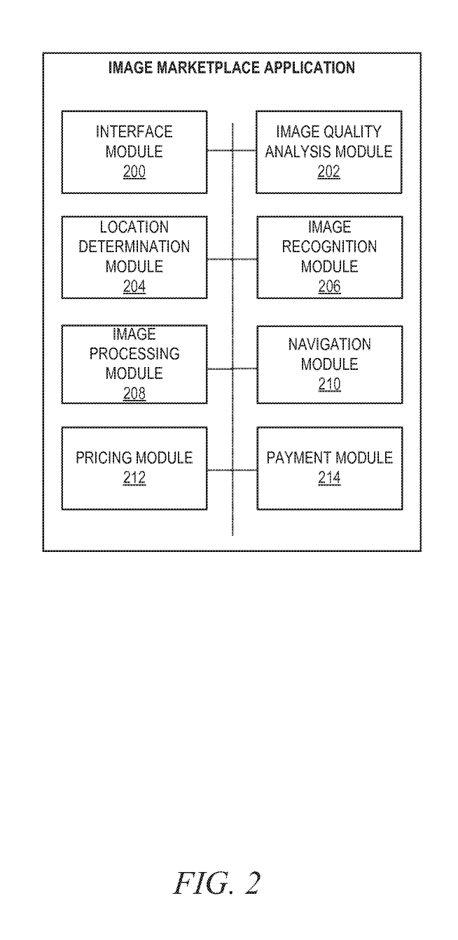

FIG. 2 is a block diagram depicting various functional components of the image marketplace application 124, which is provided as part of the network system 100, according to example embodiments. As is understood by skilled artisans in the relevant computer and Internet-related arts, each component (e.g., a module or engine) illustrated in FIG. 2 may represent a set of logic (e.g., executable software instructions) and the corresponding hardware (e.g., memory and processor) for executing the set of logic. Further, each component illustrated in FIG. 2 may be hosted on dedicated or shared server machines that are communicatively coupled to enable communications between server machines.

The image marketplace application 124 is illustrated in FIG. 2 as including an interface module 200, an image quality analysis module 202, a location determination module 204, an image recognition module 206, an image processing module 208, a navigation module 210, a pricing module 212, and a payment module 214, all configured to communicate with each other (e.g., via a bus, shared memory, a switch, or application programming interfaces (APIs)). Each of the various components of the image marketplace application 124 may access one or more network databases (e.g., the image repository), and each of the various components of the image marketplace application 124 may be in communication with one or more of the third party applications 128. Further, while the components depicted in FIG. 2 are discussed in the singular sense, it will be appreciated that in other embodiments multiple instances of any one of these components may be employed.

The interface module 200 is responsible for generating and displaying various graphical user interfaces (GUIs) for presenting information related to the functionalities discussed herein. For example, the interface module 200 generates a GUI for receiving requests for images and image services provided by the network-based image marketplace 104, and provides instructions to the client device 106 to cause the client device 106 to display the GUI. In other embodiments, the interface module 200 works in conjunction with the API server 114 to receive client requests from an application executing on the client device 106 or from the third party application 128 executing on the third party server 108.

The interface module 200 provides GUIs to receive requests of various types. For example, utilizing the GUIs provided by the interface module 200, users may request a basic image (e.g., an unenhanced image), an enhanced image (e.g., an image enhanced with one or more filters), or a composite image that includes elements of the user's own image and one or more images included in the image repository of the network-based image marketplace 104. For enhanced image requests, the GUI provided by the interface module 200 may include one or more graphical elements (e.g., buttons or drop-down menus) that allow the user to specify one or more filters to apply to the images. The GUI may also provide the user with the option to have an image enhanced according to the current lighting conditions of the user's location. For composite image requests, the interface module 200 may provide an interface that allows a user to select elements (e.g., objects, people, landmarks, or geographic features) from an image hosted by the network-based image marketplace 104 to be incorporated into the user's own image.

The image quality analysis module 202 is configured to analyze images (e.g., picture files or video files) to assess the relative quality thereof. To this end, the image quality analysis module 202 utilizes various image analysis techniques known to those skilled in the art (e.g., histogram analysis or edge detection) to derive values for various image attributes, and uses those derived values to calculate an image quality score. The image attributes describe various characteristics of an image. The image attributes assessed by the image quality analysis module 202 may, for example, include or relate to angle, brightness, color, composition, saturation, resolution (e.g., pixel density), exposure conditions, dynamic range, focal point, and motion blur, among other characteristics that may affect image quality. As an example, the image quality analysis module 202 performs a histogram analysis of an image to determine a value of the dynamic range of the image. As another example, the image quality analysis module 202 uses an edge detection analysis to determine the amount of motion blur in an image.

In determining the image quality score for images, the image quality analysis module 202 may apply a weighting to each of the determined image attribute values, and use the weighted values to calculate the image quality score. The weighting applied to each attribute value may be a predetermined weighting configured by an administrator of the network-based image marketplace 104. Not all image attributes contribute equally to the quality of an image. Thus, the weighting applied to the determined attribute values allows for certain, possibly more desirable, image attributes to have a greater impact on the determined quality of the image (e.g., as represented by the image quality score). The weighting applied to each attribute value may be adjusted over time according to heuristic methods that account for the ever-changing tastes of consumers.

In some embodiments, the image quality analysis module 202 may calculate the image quality score by summing each of the weighted image attribute values. In some embodiments, the image quality analysis module 202 calculates the image quality score by taking an average of the weighted image attribute values. Once the image quality score of an image has been calculated, the image quality analysis module 202 compares the image quality score to a predefined quality threshold for inclusion into the network-based image marketplace 104. If the image quality analysis module 202 determines that the image quality score of an image exceeds the predefined threshold, the image will be included in the network-based image marketplace 104 after further processing. Otherwise, the image is rejected from inclusion in the network-based image marketplace 104, and the interface module 200 may transmit a message to the device from which the image was received to notify the user of the device that the image will not be included in the network-based image marketplace 104.

The location determination module 204 is responsible for determining locations of images (e.g., the location where the image was captured). To this end, the location determination module 204 may access image metadata included with image files to determine the locations of images. The image metadata may include geospatial coordinates (e.g., latitude and longitude coordinates) corresponding to the location where the image was captured. Given that the geospatial coordinates included in the image metadata may not, in some instances, be completely accurate, the location determination module 204 may, in some embodiments, refine the location of the image based on objects or landmarks of known location that are visible in the image. Accordingly, the location determination module 204 may work in conjunction with the image recognition module 206 to identify objects or landmarks in the image that have a known location. In this way, the location determination module 204 may identify a relative positioning of the image, and refine the determined location accordingly.

The location determination module 204 is also responsible for determining locations of client devices (e.g., client device 106) in communication with the network-based image marketplace 104. The location determination module 204 may determine the location of a client device by requesting geolocation data (e.g., geospatial coordinates) from an embedded position component in the client device. The position component may, for example, correspond to a GPS transceiver that communicates GPS signals with a GPS satellite. The location determination module 204 may also be configured to determine a location of the client device by using an internet protocol (IP) address lookup or by triangulating a position based on nearby mobile communications towers.

The image recognition module 206 is configured to analyze images to identify items of interest in images. For example, the image recognition module 206 may identify consumer products or landmarks, such as monuments, buildings, structures, and geographic features. Accordingly, the image recognition module 206 may employ any one of several known object recognition techniques (e.g., edge detection, edge matching, greyscale matching, gradient matching, or pattern recognition) to identify the objects and landmarks in images.

The image processing module 208 is responsible for performing a number of image processing functions and services for images on the network-based image marketplace 104. For example, images that have an image quality score above the predefined threshold (e.g., images that will be sold via the network-based image marketplace 104) are provided to the image processing module 208 for removal of visible human faces to protect the privacy of individuals who may be visible in the images. Accordingly, the image processing module 208 may perform a facial recognition analysis on images to detect visible human faces, and apply one or more filters or other known image augmentation techniques to blur or otherwise obscure the detected visible human faces.

The image processing module 208 also composes image data in accordance with received user requests. The composed image data includes an image that is in accordance with the resolution and size specified in the request, if applicable. In instances in which the request is for a basic image corresponding to the location, the image processing module 208 may process the retrieved image file (e.g., a raw image file) and convert it to a format that allows for presentation, printing, and further manipulation of the image (e.g., JPEG or TIFF), if the image file is not already in such a format.

In instances in which a user has requested an enhanced image, the image processing module 208 may apply one or more image filters to images in accordance with the request. The one or more image filters applied by the image processing module 208 may, for example, augment, distort, or enhance the color, brightness, contrast, and crispness to the image, set of images, or video. The image filters applied to images may be based on user selections included with the request for the image.

In some instances, a user may desire an image of the user's current location modified with filters to mimic the current lighting settings of the user's location. In this way, the user may be provided with an image that appears to have been taken that moment by the user. As part of this process, the image processing module 208 accesses information from one or more network-based sources (e.g., websites) that describe the current lighting conditions. The image processing module 208 may, for example, access information to determine the time of day, time of year, location, and weather. Using the current lighting condition information, the image processing module 208 selects one or more filters to mimic the lighting conditions, and applies the filters to an image of the user's location, which is based on the location of a mobile device carried by the user. Once the image processing module 208 has applied the image filters to the image, the image processing module 208 convert the image to a format that allows for presentation, printing, and further manipulation of the image (e.g., JPEG or TIFF).

In some instances, a user may take an image of a location that is not of the desired quality, and in these instances, the user may wish to improve their image with elements from another image. In these instances, the image processing module 208 creates a composite image using the image taken by the user and an image retrieved from the image repository of the network-based image marketplace 104. The image processing module 208 selects elements from the retrieved image, and adds or substitutes those images into the user's image. The elements selected by the image processing module 208 may be based on user selections made via an associated interface provided by the interface module 200. The composite image created by the image processing module 208 is included in image data (e.g., an image file) that is in a format that allows for presentation, printing, and further manipulation of the image (e.g., JPEG or TIFF).

Navigation of the network-based image marketplace 104 may be facilitated by the navigation module 210. For example, the navigation module 210 may, inter alia, enable keyword or location searches of images offered for sale via the network-based image marketplace 104. The navigation module 210 may also allow users, via an associated UI, to browse various category, catalog, inventory, social network, and review data structures within the network-based image marketplace 104.

The pricing module 212 is configured to determine prices for image data composed in response to user requests for such. The pricing module 212 may determine a price of image data based on a relationship between the device from which the request was received and the location of the image. Accordingly, in determining the price of the image data, the pricing module 212 determines a relationship between the requesting device (e.g., client device 106) and the location of the image. In some embodiments, the relationship, and thus, the price of the image data, is based on a distance between a current or previous location of the requesting device and the location of the image. For example, the price of the image data may be higher the farther away the location of the requesting device is from the image location. Thus, in some embodiments, the determination of the price of the image data may include determining a location of the requesting device, determining a distance between the current location of the requesting device and the location of the image, and calculating a price for the image data based at least in part on the distance.

In some embodiments, the pricing module 212 may use the elapsed time since the requesting device was last at or near (e.g., within a predefined distance of) the location of the image in determining the relationship of the requesting device to the location of the image for purposes of determining a price for the image data. For example, a user requesting an image of a location while being physically at the location may receive the image data at no charge, while another user who has never been to the location may be charged for the same image data. Thus, in some embodiments, the determination of the price of the image data may include accessing a location history of the requesting device (e.g., client device 106), determining whether the requesting device has been at or near (within a predefined distance of) the location, determining an elapsed time (e.g., a number of days) since the requesting device was at or near the location, and calculating a price for the image data based at least in part on the elapsed time.

In some embodiments, the pricing module 212 may determine or refine the price of the image data based on various other factors including, for example, the image quality score of the image, a number of previous purchases involving the image file, an amount of the image used in generating the image data (e.g., number of pixels), particular elements (e.g., highly sought-after landmarks) used in generating the image data, or various combinations thereof.

The payment module 214 provides a number of payment services and functions to users. For example, the payment module 214 generally enables transfer of value (e.g., funds, reward points, etc.) from an account associated with one party (e.g., a sender) to another account associated with another party (e.g., a receiver). The payment module 214 may also allow users to accumulate value (e.g., in a commercial currency, such as the U.S. dollar, or a proprietary currency, such as “points”) in accounts, and then later to redeem the accumulated value for products (e.g., images).

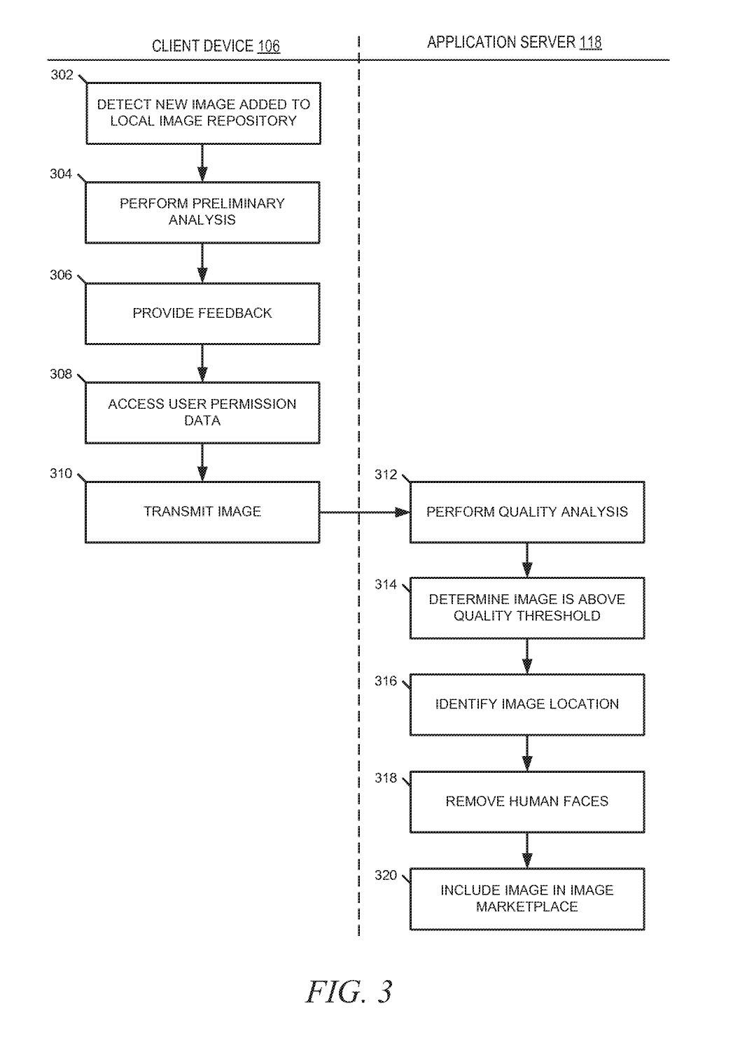

FIG. 3 is an interaction diagram depicting example exchanges between the client device 106 and the application server 118, according to example embodiments. The client device 106 has an embedded camera and a camera application that allows a user to capture images using the camera and store the images in a local image repository (e.g., a machine-readable medium of the client device 106). As shown, the process begins at operation 302, where the upload application 112 executing on the client device 106 detects a new image (e.g., a data file representing an image) added to the local image repository of the client device 106. In some embodiments, the new image is an image recently captured by a user of the client device 106 using the embedded camera. In some embodiments, the image is an image purchased by the user from the network-based image marketplace 124, and enhanced by the user using services provided by the network-based image marketplace 124 or other suitable image editing software. In this way, the network-based image marketplace 124 also allows for a secondary market of enhanced images that are based on previously purchased high-quality images from the network-based image marketplace 124.

Consistent with some embodiments, the upload application 112 performs a preliminary analysis of the new image at operation 304. The preliminary analysis may include determining values for image attributes, and determining whether the image is likely to be included in the network-based image marketplace 104 based on the image attribute values. At operation 306, the upload application 112 presents feedback to the user based on the preliminary image analysis. The feedback includes an indication of whether the image is likely to be included in the network-based image marketplace 104.

At operation 308, the upload application 112 accesses locally stored user permission data to determine whether the user has authorized the uploading of the new image. The user permission data includes user preferences with respect to uploading images to the network-based image marketplace 104. Based on the user permission data indicating that the user has authorized the uploading of the new image, at operation 310, the client device 106 transmits (e.g., uploads) the new image to the application server 118.

At operation 312, upon receiving the new image uploaded from the client device 106, the application server 118 performs an image quality analysis on the image. The image quality analysis includes determining image attribute values (e.g., corresponding to angle, brightness, color, composition, saturation, resolution, exposure conditions, dynamic range, focal point, motion blur, or other characteristics that may affect image quality), applying a weighting to each of the image attribute values, and calculating an image quality score using the weighted image attribute values.

At operation 314, the application server 118 uses the results of the image quality analysis to determine whether the image is above a quality threshold for inclusion into the network-based image marketplace 104. For example, the application server 118 determines whether the image quality score exceeds a predefined threshold quality score.

Once the application server 118 determines that the image is above the quality threshold, at operation 316, the application server 118 identifies the location where the image was taken. The determination of image location may include accessing metadata of the image to identify geospatial coordinates corresponding to the image location. The image location may be refined by using known image recognition techniques to identify objects or landmarks of known location in the image.

At operation 318, the application server 118 removes human faces visible in the image. The removal of human faces includes detecting one or more human faces in the image and applying one or more filters or other known image augmentation techniques to blur or otherwise obscure the detected human faces.

At operation 320, the application server 118 causes the image to be included in the network-based image marketplace 104. Specifically, the application server 118 stores an image file in the image repository (e.g., in database 122) that includes the image with human faces removed. The application server 118 also associates the image file with the location determined at operation 316. The location may be stored as metadata of the image file (e.g., as a metadata tag) or in a separate record that is associated with the image file. In this manner, images that are included in the image repository are indexed according to location so as to enable the images included in the image repository to be grouped and searched by location.

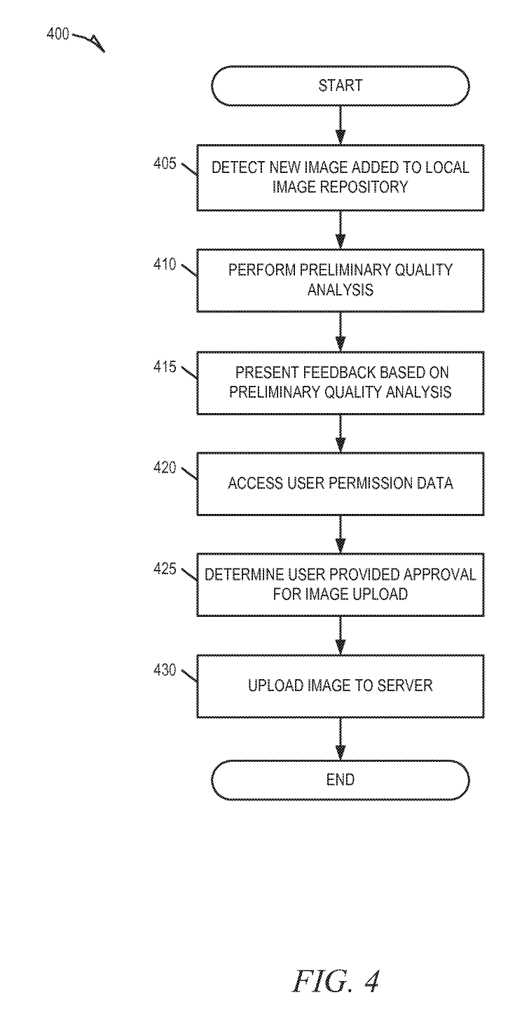

FIG. 4 is a flow chart illustrating a method 400 for providing images to a server hosting the image marketplace application 124, according to an example embodiment. The method 400 may be embodied in computer-readable instructions for execution by one or more processors such that the steps of the method 400 may be performed in part or in whole by the client device 106. In particular, the method 400 may be carried out by the upload application 112. Accordingly, the method 400 is described below by way of example with reference thereto. However, it shall be appreciated that the method 400 may be deployed on various other hardware configurations and is not intended to be limited to the functional components of the upload application 112.

At operation 405, the upload application 112 detects a new image added to a local image repository of the client device 106. The image may be added to the image repository by a camera application executing on the client device 106 and operating in conjunction with a camera communicatively coupled to the client device 106 (e.g., a smart phone with an embedded camera).

Consistent with some embodiments, at operation 410, the upload application 112 performs a preliminary image quality analysis on the new image. The preliminary image quality analysis performed by the upload application 112 may be similar in nature to the image quality analysis performed by the image quality analysis module 202 of the image marketplace application 124. For example, as part of the preliminary analysis the upload application 112 may determine values for image attributes such as color, motion blur, exposure, dynamic range, and focal point. The upload application 112 may then use the determined image attribute values to calculate a preliminary image quality score that may be used to provide a preliminary indication of whether the image is likely to be included by the image marketplace hosted by the image marketplace application 124.

Consistent with some embodiments, at operation 415, the upload application 112 presents feedback (e.g., on a display of the client device 106) that is based on the preliminary image quality analysis. The feedback provides the user of the client device 106 with an indication of whether the image is likely to be included in the image marketplace hosted by the image marketplace application 124. The feedback may, for example, include the preliminary image quality score. At this time, the user may also be given the opportunity to decline to have the image uploaded to the image marketplace application 124 (e.g., through an additional window or other UI element). If the user does decline, the user's preference for not uploading the image is stored as user permission data (e.g., in a local storage medium of the client device 106 or in the database 122).

At operation 420, the upload application 112 accesses the user permission data (e.g., stored on the client device 106 or in the database 122). The user permission data includes the user preferences for uploading images to the image marketplace application 124. The user preferences may include a broad approval or disapproval of all image uploads, or may include one or more constraints for uploading images. For example, a user may specify that only images taken at certain locations or at certain times may be uploaded.

At operation 425, the upload application 112 determines that the user has provided approval for the image upload based on the information in the user permission data. At operation 430, the upload application 112 uploads the image to the application server 118 hosting the image marketplace application 124 in response to determining that the user has provided approval for the image upload. In some embodiments, the upload application 112 may provide the application server 118 with a raw image file corresponding to the image.

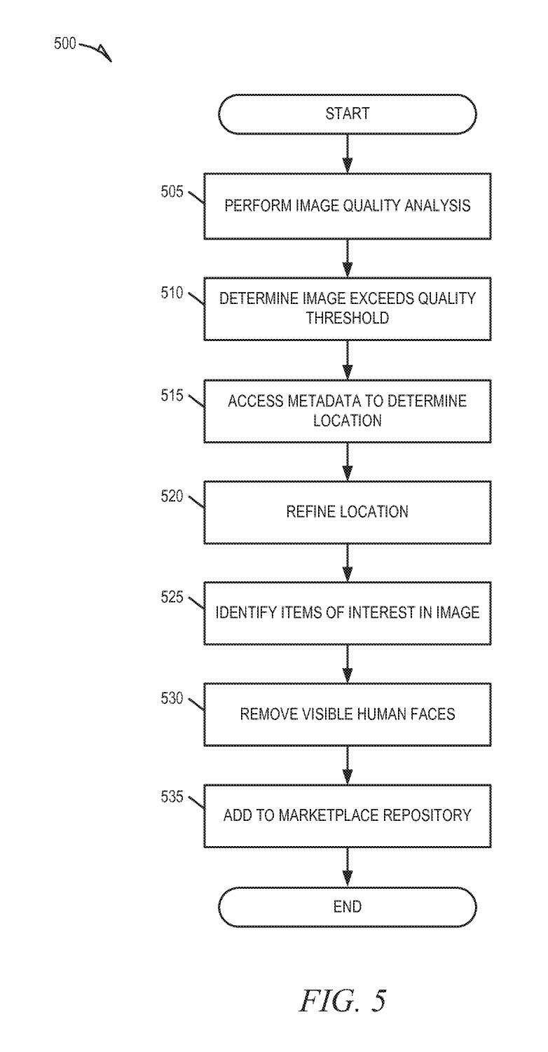

FIG. 5 is a flow chart illustrating a method 500 for populating an image repository associated with the image marketplace application 124, according to an example embodiment. The method 500 may be embodied in computer-readable instructions for execution by one or more processors such that the steps of the method 500 may be performed in part or in whole by the application server 118. In particular, the method 500 may be carried out by the functional components of the image marketplace application 124. Accordingly, the method 500 is described below by way of example with reference thereto. However, it shall be appreciated that the method 500 may be deployed on various other hardware configurations and is not intended to be limited to the functional components of the image marketplace application 124. For example, at least a portion of the operations of the method 500 may be performed by the client device 106, in some embodiments.

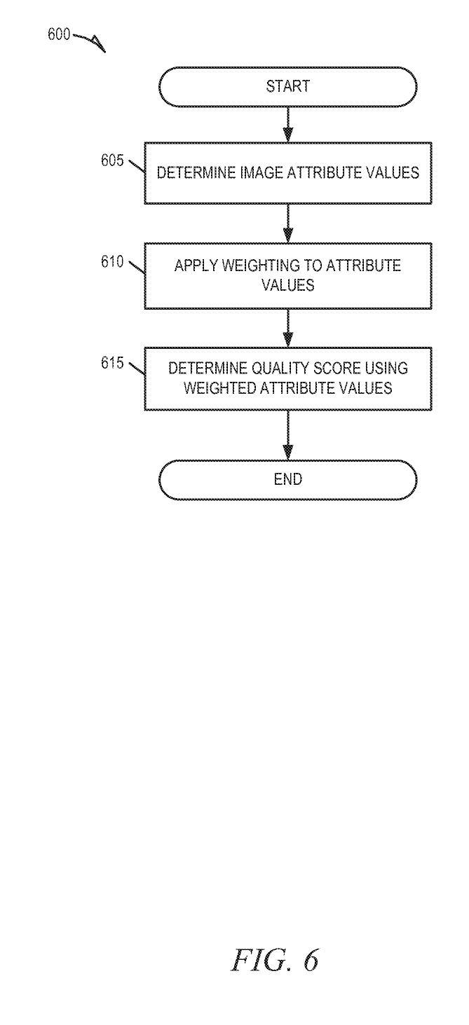

The method 500 may be initiated after receiving image data from the upload application 112 including an image. At operation 505, the image quality analysis module 202 performs an image quality analysis on an image included in image data (e.g., an image file) received from the upload application 112. The image quality analysis performed by the image quality analysis module 202 may include determining an image quality score for the image. Further details regarding the operation 505 according to an example embodiment are discussed below in reference to FIG. 6.

At operation 510, the image quality analysis module 202 determines whether the image exceeds an image quality threshold for inclusion into the image marketplace. The image quality analysis module 202 may determine whether the image exceeds the image quality threshold by comparing the image quality score (calculated as part of the image quality analysis of operation 505) to a predefined image quality score threshold. If the image quality score is below the quality score threshold, the image marketplace application 124 rejects the image, and the interface module 200 transmits a message to the client device 106 to notify the user of the device that the image will not be included in the image marketplace.

Based on the image exceeding the quality threshold, the method 500 proceeds to operation 515, where the location determination module 204 determines a location corresponding to the image (e.g., the location where the image was taken) included in the image data. The location determination module 204 determines the location by accessing image metadata (e.g., geospatial metadata) included in the image data. The image metadata may include geospatial coordinates (e.g., latitude and longitude coordinates) corresponding to the location where the image was captured.

In some instances, the geospatial coordinates included in the image metadata may not be completely accurate. Thus, in some embodiments, the location determination module 204 refines the location of the image using known image recognition techniques, at operation 520. In particular, the location determination module 204 may work in conjunction with the image recognition module 206 to identify objects or landmarks in the image that have a known location. In this way, the location determination module 204 may identify a relative positioning of the image, and refine the determined location accordingly.

At operation 525, the image recognition module 206 identifies any items of interest that may be visible in the image using known image recognition techniques. The items of interest may include recognizable objects such as consumer products or landmarks, such as monuments, buildings, structures, and geographic features, for example.

At operation 530, the image processing module 208 removes any human faces that may be visible in the image. The image processing module 208 may remove visible faces by first analyzing the image to detect human faces, and applying one or more filters or other known image augmentation techniques to blur or otherwise obscure the detected visible human faces.

At operation 535, the image processing module 208 adds the image to the image marketplace. In particular, the image processing module 208 stores image data (e.g., an image file) in the image repository of the database 122 that includes a copy of the image with all visible human faces removed (e.g., blurred or otherwise obscured). The image data stored in the image repository also includes geospatial data corresponding to the refined location of the image determined at operation 520. The image data may further include one or more metadata tags corresponding to the items of interest identified in the image at operation 525. By storing images along with geospatial metadata and other metadata tags, the image marketplace application 124 enables users to search for images (e.g., using the navigation module 210) by location or by items of interest.

FIG. 6 is a flow chart illustrating a method 600 for performing image quality analysis, according to an example embodiment. The method 600 may, in some embodiments, correspond to operation 505 of the method 500. The method 600 may be embodied in computer-readable instructions for execution by one or more processors such that the steps of the method 600 may be performed in part or in whole by the application server 118. In particular, the method 600 may be carried out by the image quality analysis module 202 of the image marketplace application 124. Accordingly, the method 600 is described below by way of example with reference thereto. However, it shall be appreciated that the method 600 may be deployed on various other hardware configurations and is not intended to be limited to the functional components of the image marketplace application 124.

At operation 605, the image quality analysis module 202 determines values for various image attributes (e.g., color distribution, exposure conditions, focal point, and motion blur, among others) of an image. The image is included in image data received from the client device 106 for possible inclusion in the image marketplace. The image quality analysis module 202 derives the image attribute values using one or more image analysis techniques known to those skilled in the art, such as, for example, a histogram analysis, edge detection analysis, and edge matching analysis, among others.

At operation 610, the image quality analysis module 202 applies a weighting to each of the determined attribute values. The weighting applied to each attribute value may be a predetermined weighting configured by an administrator of the image marketplace.

At operation 615, the image quality analysis module 202 calculates an image quality score for the image using the weighted image attribute values. As an example, the image quality analysis module 202 calculates the image quality score by summing each of the weighted image attribute values. As another example, the image quality analysis module 202 calculates the image quality score by taking the average of the weighted image attribute values.

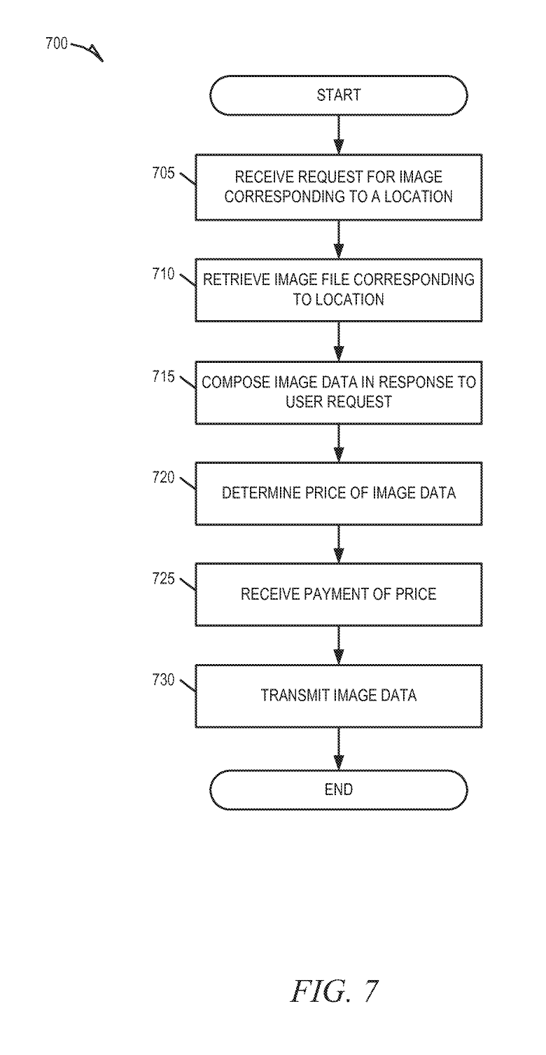

FIG. 7 is a flow chart illustrating a method 700 for providing image data in response to a user request, according to an example embodiment. The method 700 may be embodied in computer-readable instructions for execution by one or more processors such that the steps of the method 700 may be performed in part or in whole by the application server 118. In particular, the method 700 may be carried out by the functional components of the image marketplace application 124. Accordingly, the method 700 is described below by way of example with reference thereto. However, it shall be appreciated that the method 700 may be deployed on various other hardware configurations and is not intended to be limited to the functional components of the image marketplace application 124.

At operation 705, the interface module 200 receives a request from the client device 106 for an image corresponding to a particular location. The request may be submitted by a user via a GUI presented on the client device 106, or the request may be triggered by an application executing on the client device 106 upon the application determining that the client device 106 is at or near the particular location. The request includes an identifier of the location (referred to herein as a “location identifier”) such as a plain text description, an address, or geospatial coordinates. The request may further specify a particular resolution or size for the requested image.

In some instances, the received request is for a basic image depicting the location (e.g., an unenhanced image), while in other instances the received request is for an enhanced image (e.g., an image with one or more applied filters) corresponding to the location. In still other instances, the request may be to create a composite image using one or more images retrieved from the image repository and another image submitted with the request.

At operation 710, the image processing module 208 retrieves an image file (e.g., a raw image file) from the image repository that includes an image corresponding to the location specified in the request received by the interface module 200. The image processing module 208 may identify and retrieve the image file using the location identifier included in the request.

At operation 715, the image processing module 208 composes image data in accordance with the received request. The composed image data includes an image that is in accordance with the resolution and size specified in the request, if applicable. In instances in which the request is for a basic image corresponding to the location, the image processing module 208 processes the retrieved image file (e.g., a raw image file) and converts it to a format that allows for presentation, printing, and further manipulation of the image (e.g., JPEG or TIFF), if the image file is not already in such a format.

In instances in which the request is for an enhanced image corresponding to the location, the image processing module 208 applies one or more filters to the image before converting it to a format that allows for presentation, printing, and further manipulation (e.g., JPEG or TIFF). The filters applied to the image may be based on one or more user selections specified in the received request, or based on the current lighting conditions of the location of the client device 106. In embodiments where the applied filters are based on the current lighting conditions of the location of the client device 106, the operation of composing the image data may include determining current lighting conditions (e.g., based on time of day, time of year, weather, and location), selecting one or more image filters to mimic the current lighting conditions, and applying the selected image filters to the image.

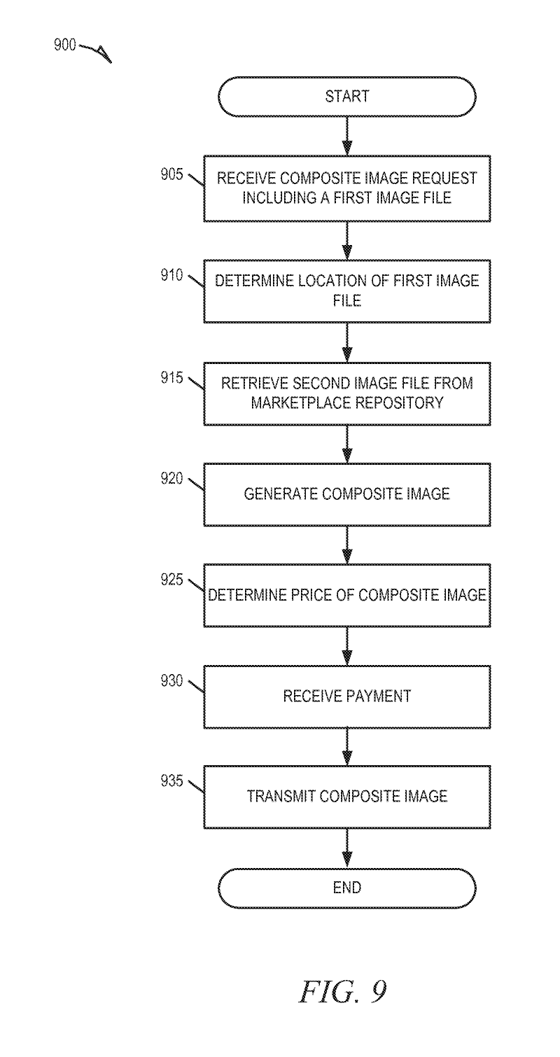

In instances in which the request is for a composite image, the image processing module 208 creates a composite image using the retrieved image file and an image file provided along with the request. Further details related to the processing of requests for composite images are discussed below in reference to FIG. 9.

At operation 720, the pricing module 212 determines a price of the image data based on a relationship between the client device 106 and the location. Accordingly, the operation of determining the price of the image data includes determining the relationship between the client device 106 and the location. For example, in some embodiments, the price of the image data may be based on the distance between a current or previous location of the client device 106 and the location of the image. In some instances, the price of the image data may be higher the farther away the location of the client device 106 is from the image location. Thus, in some embodiments, the determination of the price of the image data may include determining a location of the client device 106, determining a distance between the current location of the client device 106 and the location of the image, and calculating a price for the image data based at least in part on the distance.

In some embodiments, the pricing module 212 may factor in the elapsed time since the client device 106 was last at or near (e.g., within a predefined distance of) the location of the image in determining the relationship of the client device 106 to the location of the image for purposes of determining a price for the image data. For example, a user who has visited the location in the past week may receive corresponding image data at a lower cost than another user who has not been to the location for several years. Thus, in some embodiments, the determination of the price of the image data may include accessing a location history of the client device 106, determining whether the client device 106 has been at or near (within a predefined distance of) the location, determining an elapsed time (e.g., a number of days) since the client device 106 was at or near the location, and calculating a price for the image data based at least in part on the elapsed time.

In some embodiments, the determination of the price of the image data includes accessing calendar data of the client device 106, determining whether the client device 106 has been at or near (within a predefined distance of) the location based on the calendar data, determining an elapsed time (e.g., a number of days) since the client device 106 was at or near the location, and calculating a price for the image data based at least in part on the elapsed time.

Consistent with some embodiments, the pricing module 212 further refines the price of the image data based on various factors including, for example, the image quality score of the image, a number of previous purchases involving the image file, an amount of the image file used in generating the image data (e.g., number of pixels), particular elements (e.g., highly sought-after landmarks) used in generating the image data, or various combinations thereof.

At operation 725, the payment module 214 receives a payment of the price (e.g., from an account associated with the user of the client device 106). In response to the payment module 214 receiving the payment, the interface module 200 transmits the image data to the client device 106 in operation 730.

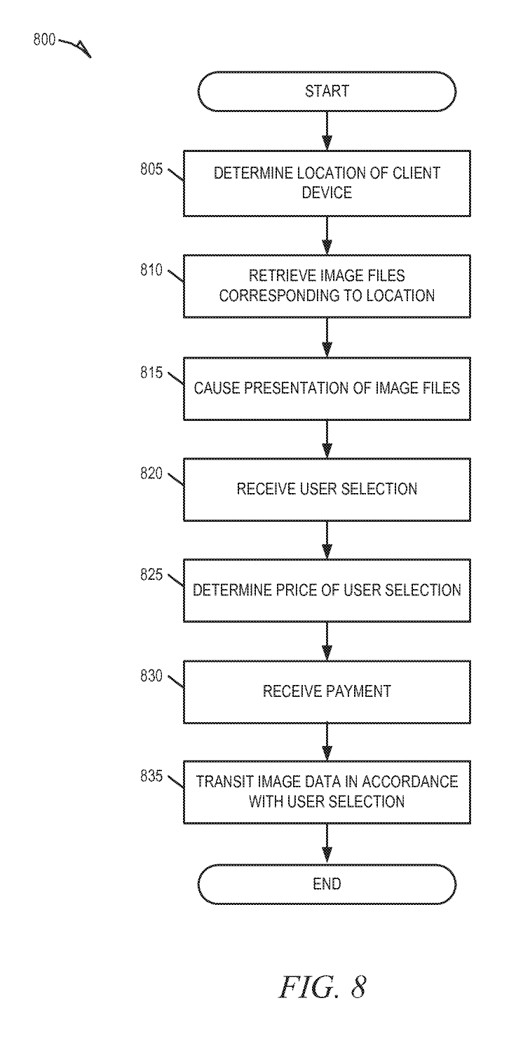

FIG. 8 is a flow chart illustrating a method 800 for providing an image file stored in the image repository, according to an example embodiment. The method 800 may be embodied in computer-readable instructions for execution by one or more processors such that the steps of the method 800 may be performed in part or in whole by the application server 118. In particular, the method 800 may be carried out by the functional components of the image marketplace application 124. Accordingly, the method 800 is described below by way of example with reference thereto. However, it shall be appreciated that the method 800 may be deployed on various other hardware configurations and is not intended to be limited to the functional components of the image marketplace application 124.

At operation 805, the location determination module 204 determines the current location of the client device 106. The location determination module 204 may determine the location of the client device 106 by requesting geolocation information (e.g., geospatial coordinates) from the client device 106 maintained by an embedded position component (e.g., a Global Position System (GPS) component).

At operation 810, the image processing module 208 retrieves image files from the image repository that include images corresponding to the determined location of the client device 106. At operation 815, the interface module 200 transmits a set of instructions to the client device 106 that causes the client device 106 to present the images in a user interface that allows users to select one or more of the images. At operation 820, the interface module 200 receives a user selection of one or more images via the user interface presented on the client device 106.

At operation 825, the pricing module 212 determines a price for the user selection of the one or more images according to one or more methodologies discussed herein. At operation 830, the payment module 214 receives a payment of the price determined by the pricing module 212. At operation 835, the interface module 200 transmits image data to the client device 106 in response to receiving the payment. The image data includes the one or more image selected by the user.

FIG. 9 is a flow chart illustrating a method for providing a composite image, according to an example embodiment. The method 900 may be embodied in computer-readable instructions for execution by one or more processors such that the steps of the method 900 may be performed in part or in whole by the application server 118. In particular, the method 900 may be carried out by the functional components of the image marketplace application 124. Accordingly, the method 900 is described below by way of example with reference thereto. However, it shall be appreciated that the method 900 may be deployed on various other hardware configurations and is not intended to be limited to the functional components of the image marketplace application 124.

At operation 905, the interface module 200 receives a request from the client device 106 for a composite image. The request includes a first image file to be used in creating the composite image. The first image file includes a first image.

At operation 910, the location determination module 204 determines a location corresponding to the first image file. In some embodiments, the location determination module 204 determines the location corresponding to the first image file based on user provided information included as part of the request. In some embodiments, the location determination module 204 determines the location by accessing image metadata (e.g., geospatial metadata) of the first image file. The image metadata may include geospatial coordinates (e.g., latitude and longitude coordinates) corresponding to the location where the first image was captured. The location determination module 204 may further refine the determined location by working in conjunction with the image recognition module 206 to identify objects or landmarks in the first image that have a known location.

At operation 915, the image processing module 208 retrieves a second image file (e.g., a raw image file) from the image repository that includes a second image corresponding to the location of the first image file. The image processing module 208 identifies and retrieve the second image file using the location identified by the location determination module 204.

At operation 920, the image processing module 208 generates a composite image using the first and second image files in accordance with the request. The composite image may be generated in one of several various image formats that allow the image to be presented, printed, or further manipulated (e.g., JPEG or TIFF). The generating of the composite image includes selecting elements (e.g., a landscape, a skyline, a landmark, an object, etc.) of the second image and replacing elements of the first image with the selected elements from the second image. The elements selected from the second image for inclusion in the composite image may be based on user input (e.g., a user may select the elements from the second image for inclusion in the composite image).

At operation 925, the pricing module 212 determines a price of the composite image in accordance with the various methodologies discussed herein. At operation 930, the payment module 214 receives a payment of the price (e.g., from an account associated with the user of the client device 106). At operation 935, in response to receiving the payment, the interface module 200 transmits image data including the composite image to the client device 106.

Machine Architecture

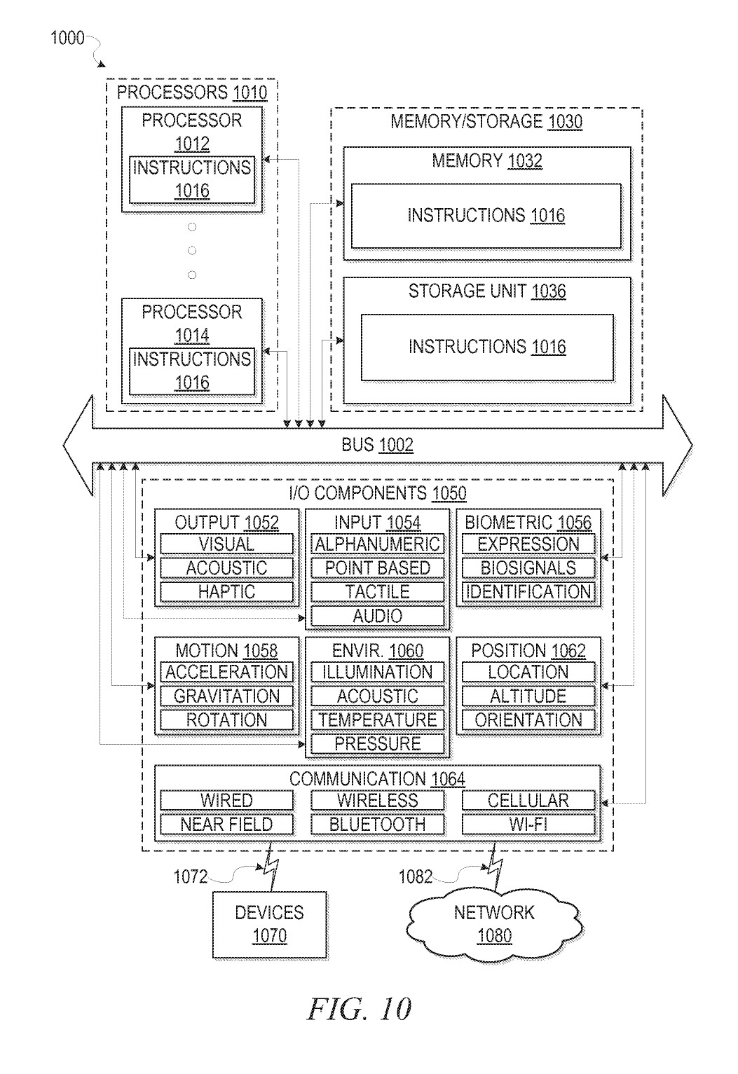

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example, the instructions 1016 may include executable code that causes the machine 1000 to execute the image marketplace application 124 and the associated functionalities described herein. These instructions transform the general, non-programmed machine into a particular machine programmed to carry out the described and illustrated functions of the image marketplace application 124 in the manner described herein. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. By way of non-limiting example, the machine 1000 may comprise or correspond to a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory/storage 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1012 and a processor 1014 that may execute the instructions 1016. The term “processor” is intended to include a multi-core processor that may comprise two or more independent processors (sometimes referred to as “cores”) that may execute instructions contemporaneously. Although FIG. 10 shows multiple processors, the machine 1000 may include a single processor with a single core, a single processor with multiple cores (e.g., a multi-core processor), multiple processors with a single core, multiple processors with multiples cores, or any combination thereof.

The memory/storage 1030 may include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of the processors 1010 are examples of machine-readable media.

As used herein, “machine-readable medium” means a device able to store instructions and data temporarily or permanently, and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine (e.g., processors 1010), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion, and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062, among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), acoustic sensor components (e.g., one or more microphones that detect background noise), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072 respectively. For example, the communication components 1064 may include a network interface component or other suitable device to interface with the network 1080. In further examples, the communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a Universal Serial Bus (USB)).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

Transmission Medium

In various example embodiments, one or more portions of the network 1080 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to the devices 1070. The term “transmission medium” shall be taken to include any intangible medium that is capable of storing, encoding, or carrying the instructions 1016 for execution by the machine 1000, and includes digital or analog communications signals or other intangible media to facilitate communication of such software.

Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network 102.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice.

Language

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

The invention claimed is:

1. A method for generating a composite image, the method comprising:
receiving, from a user device via an application running on the user device, a first image captured by a camera on the user device and a request for a composite image based on the first image;
querying a database of images based on the first image to identify a second image;
providing the second image to the user device for presentation via the application running on the user device;
receiving, via the application running on the user device, a selection of one or more image elements from the second image;
generating the composite image by replacing one or more elements of the first image with the selected one or more elements from the second image; and
providing the composite image to the user device.

2. The method of claim 1, wherein the second image is identified based at least in part on a location associated with the first image and location information associated with the second image.

3. The method of claim 1, wherein the second image is identified based at least in part on an item identified in each of the first image and the second image using image recognition.

4. The method of claim 1, wherein the composite image is generated in part by:
selecting one or more image filters to apply; and
applying the one or more image filters to at least a portion of the composite image.

5. The method of claim 4, wherein the one or more image filters are selected based on current lighting conditions of a current location of the user device.

6. The method of claim 5, further comprising:
determining the current location of the user device; and
accessing lighting information from one or more sources, the lighting information corresponding to the current location of the user device and describing one or more lighting conditions of the current location of the user device.

7. The method of claim 1, wherein the method further comprises determining a price for the second image based on at least one selected from the following: a distance between a current location of the user device and a location corresponding to the first image; an elapsed time since the user device was located at the location corresponding to the first image; and the one or more image elements selected from the second image.

8. One or more computer storage media storing computer-useable instructions that, when used by one or more processors, cause the one or more processors to perform operations comprising:
receiving, from a user device via an application running on the user device, a first image captured by a camera on the user device and a request for a composite image based on the first image;
querying a database of images based on the first image to identify a second image;
providing the second image to the user device for presentation via the application running on the user device;
receiving, via the application running on the user device, a selection of one or more image elements from the second image;
generating the composite image by replacing one or more elements of the first image with the selected one or more elements from the second image; and
providing the composite image to the user device.

9. The media of claim 8, wherein the second image is identified at least in part based on a location associated with the first image and location information associated with the second image.

10. The media of claim 8, wherein the second image is identified at least in part based on an item identified in each of the first image and the second image using image recognition.

11. The media of claim 8, wherein the composite image is generated in part by:
selecting one or more image filters to apply; and
applying the one or more image filters to at least a portion of the composite image.

12. The media of claim 11, wherein the one or more image filters are selected based on current lighting conditions of a current location of the user device.

13. The media of claim 12, wherein the operations further comprise:
determining the current location of the user device; and
accessing lighting information from one or more sources, the lighting information corresponding to the current location of the user device and describing one or more lighting conditions of the current location of the user device.

14. The media of claim 8, wherein the operations further comprise determining a price for the second image based on at least one selected from the following: a distance between a current location of the user device and a location corresponding to the first image; an elapsed time since the user device was located at the location corresponding to the first image; and the one or more image elements selected from the second image.

15. A computer system comprising:
one or more processors; and
one or more computer storage media storing computer-useable instructions that cause the one or more processors to:
receive, from a user device via an application running on the user device, a first image captured by a camera on the user device and a request for a composite image based on the first image;
query a database of images based on the first image to identify a second image;
provide the second image to the user device for presentation via the application running on the user device;
receive, via the application running on the user device, a selection of one or more image elements from the second image;
generate the composite image by replacing one or more elements of the first image with the selected one or more elements from the second image; and
provide the composite image to the user device.

16. The system of claim 15, wherein the second image is identified at least in part based on a location associated with the first image and location information associated with the second image.

17. The system of claim 15, wherein the second image is identified at least in part based on an item identified in each of the first image and the second image using image recognition.

18. The system of claim 15, wherein the composite image is generated in part by:
selecting one or more image filters to apply; and
applying the one or more image filters to at least a portion of the composite image.

19. The system of claim 18, wherein the selecting of the one or more image filters is based on current lighting conditions of a current location of the user device.

20. The system of claim 15, wherein the one or more computer storage media further cause the one or more processors to determine a price for the second image based on at least one selected from the following: a distance between a current location of the user device and a location corresponding to the first image; an elapsed time since the user device was located at the location corresponding to the first image; and the one or more image elements selected from the second image.
